(19) United States
(12) Patent Application Publication
(10) Pub. No.: US 2026/0129516 A1
(43) Pub. Date: May 7, 2026

(54) ADAPTIVE MODEM FOR WIRELESS DEVICES

(71) Applicant: Cypress Semiconductor Corporation, San Jose, CA (US)

(72) Inventors: Avik Santra, Irvine, CA (US); Kiran Uln, Pleasanton, CA (US)

(73) Assignee: Cypress Semiconductor Corporation, San Jose, CA (US)

(21) Appl. No.: 19/189,504

(22) Filed: Apr. 25, 2025

Related U.S. Application Data
(60) Provisional application No. 63/716,898, filed on Nov. 6, 2024.

(51) Int. Cl. H04W 28/18; H04L 5/00; H04L 25/02

(52) U.S. Cl. CPC H04W 28/18; H04L 5/0007; H04L 5/0048; H04L 25/0202

(57) ABSTRACT

Methods and systems for an adaptive modem for wireless devices which includes, among other things, receiving a wireless signal transmitted by an access point, identifying waveform characteristics of the wireless signal, determining, based on the waveform characteristics, whether the wireless signal contains beacon information, determining, based on the waveform characteristics, a wireless standard for the wireless signal, responsive to determining that the wireless standard implemented by the wireless signal is a first type of wireless standard and that the wireless signal contains beacon information, obtaining a first pre-trained weight set for the first type of wireless standard, applying the first pre-trained weight set to a first machine learning (ML) model to configure the first ML model for the first type of wireless standard, and recovering, using the first ML model configured for the first type of wireless standard, one or more bits of the beacon information from the wireless signal.

### TECHNICAL FIELD

This application claims the benefit of U.S. Provisional Patent Application 63/716,898, filed Nov. 6, 2024, which is incorporated herein by reference.

### TECHNICAL FIELD

This disclosure relates to wireless devices and, more specifically, to an adaptive modem for wireless devices.

### BACKGROUND

Wireless devices commonly implement multiple wireless standards that operate in shared frequency bands. For example, Wireless Local Area Network (WLAN) technologies, including Wi-Fi®, and Wireless Personal Area Network (WPAN) technologies, including Bluetooth® (BT), Bluetooth® Low Energy (BLE), and Institute of Electrical and Electronics Engineers (IEEE) 802.15.4, share wireless communication bands. These multi-standard wireless devices require specialized processing for each standard's unique requirements.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 is a block diagram of an exemplary wireless network with a station device having an adaptive modem, in accordance with implementations of the present disclosure.

FIG. 2 is an exemplary diagram of an adaptive modem component, in accordance with implementations of the present disclosure.

FIG. 3A is an exemplary diagram of an adaptive modem for WPAN signal, in accordance with implementations of the present disclosure.

FIG. 3B is an exemplary diagram of an adaptive modem for WPAN signal, in accordance with implementations of the present disclosure.

FIG. 4 depicts a flow diagram of an example method for processing a wireless signal using an adaptive modem, in accordance with implementations of the present disclosure.

### DETAILED DESCRIPTION

Aspects of the present disclosure relate to adaptive modem for wireless devices. Wireless devices incorporate modems that execute physical layer (PHY) processing chains to convert radio frequency (RF) signals into digital data. These chains follow a sequence of signal processing stages: front-end corrections for hardware imperfections, such as bias, imbalance, intermodulation, synchronization and timing recovery, transformation, and equalization, and, finally, demodulation and decoding, respectively.

The transformation and equalization stages for processing wireless signals differ significantly between wireless local area network (WLAN) and wireless personal area network (WPAN) standards based on their waveform characteristics. WLAN devices use spreading techniques such as orthogonal frequency division multiplexing (OFDM), which splits data across multiple frequency subcarriers for parallel transmission, and direct sequence spread spectrum (DSSS), which spreads signals across a wider bandwidth to resist interference. WLAN devices also use modulation schemes like binary phase shift keying (BPSK), which modulates phase changes to represent binary data, differential binary phase shift keying (DBPSK), which modulates phase shifts between binary data, and differential quadrature phase shift keying (DQPSK), which modulates phase shifts to encode multiple bits. WPAN devices, focusing on power efficiency, use simpler modulation schemes such as gaussian frequency shift keying (GFSK), which modulates frequency with a gaussian filter for stability, or 8-phase differential phase shift keying (8DPSK), which encode data through eight distinct phase changes.

To support multiple standards, the current implementation in wireless devices includes separate modems for each standard. Each modem, implementing a WLAN standard or a WPAN standard, independently processes the full PHY chain. This includes front-end corrections, demodulation, and decoding, even for simple tasks like beacon detection. However, the current implementation increases hardware duplication and power consumption while reducing energy efficiency, which poses significant challenges for battery-powered devices.

Aspects and embodiments of the present disclosure address these and other limitations of the existing technology by implementing a machine learning (ML) model with a plurality of pre-trained weight sets that can be dynamically selected for configuring the ML model for a wireless standard of a plurality of wireless standards. For example, a radio frequency (RF) interface of a station device (STA) receives a wireless signal transmitted by an access point (AP). The received wireless signal is provided to a physical layer (PHY) of the STA which includes the ML model.

The PHY of the STA identifies waveform characteristics of the wireless signal, which include various properties defining the signal's structure and behavior. These characteristics can consist of the spreading technique and the modulation scheme used in the wireless signal. The spreading technique might be OFDM or DSSS, while the modulation scheme could be BPSK, DBPSK, GFSK, DQPSK, or 8DPSK. Each wireless standard defines specific waveform characteristics, determining which spreading techniques and modulation schemes are permissible for transmitting and receiving wireless signals. For instance, IEEE 802.11g/ac/ax standards employ OFDM as the spreading technique, utilizing modulation schemes such as BPSK for beacons and higher-order QAM for data transmission. Conversely, IEEE 802.11b uses DSSS with modulation schemes like DBPSK for 1 Mbps and DQPSK for 2 Mbps. Bluetooth Classic, which does not use a spreading technique, relies on modulation schemes such as GFSK for basic rates and more advanced options like DQPSK and 8DPSK for enhanced data rates. By analyzing the waveform characteristics of the wireless signal, the PHY determines the specific wireless standard of the wireless signal from a range of possible standards. Additionally, the PHY of the STA determines a spreading technique of the wireless signal.

If the wireless standard implemented by the wireless signal is the WLAN standard and the spreading technique of the wireless signal is ODFM or DSSS, the PHY determines whether the wireless signal contains beacon information. If the wireless signal contains beacon information, the PHY obtains pre-trained weights for the WLAN and the spreading technique. The PHY applies the pre-trained weights to the ML model. The PHY provides the wireless signal to ML model with the applied pre-trained weights to recover beacon information from the wireless signal. If the PHY determines that the wireless signal does not contain beacon information, the PHY processes the wireless signal using a processing chain associated with the wireless standard and the spreading technique to recover data from the wireless signal.

If the wireless standard implemented by the wireless signal is the WPAN standard, the PHY obtains pre-trained weights for WPAN. The PHY applies the pre-trained weights for WPAN to the ML model. The PHY provides the wireless signal to ML model with the applied pre-trained weights to recover data from the wireless signal.

Aspects of the present disclosure overcome these deficiencies and others by enabling a single receiver to adapt to various wireless standard, thereby reducing computational complexity and power consumption.

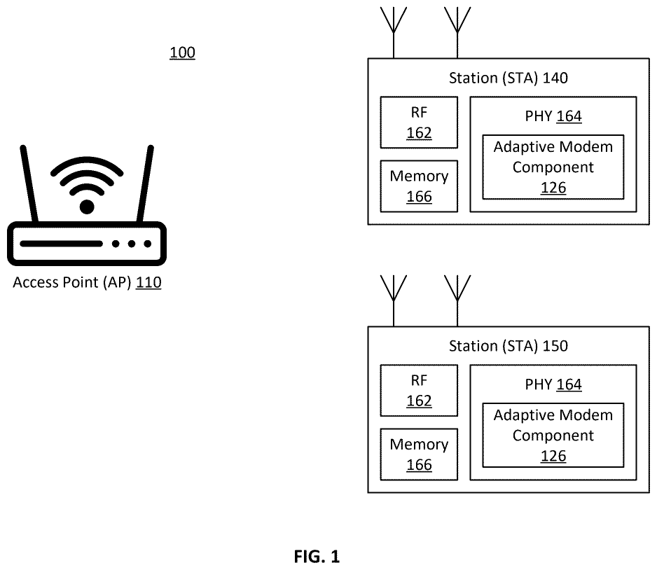

FIG. 1 is a block diagram of an exemplary illustration of a wireless network 100 that has one or more station devices, in accordance with implementations of the present disclosure. The wireless network 100 may be a wireless local area network (WLAN), wireless wide area network (WWAN), wireless metropolitan area network (WMAN), wireless personal area network (PAN), and so on. The wireless network 100 may include a station device (STA) operating as an access point 110. The wireless network 100 may include one or more wireless devices, such as station device (STA) 140 and station device (STA) 150. STA 140 and/or STA 150 may establish a wireless connection with the AP 110. The wireless connection provided by AP 110 may use any bands, such as the 2.4 GHz regulatory domain, the 5 GHz domain, the 60 GHz domain, the 6 GHz domain, or any other frequency band.

STA 140 and/or STA 150 includes, but is not limited to, a radio frequency front-end circuitry (RF) 162, a physical layer (PHY) 164, and a memory 166. RF 162 is responsible for handling the radio signals involved in wireless communication, supporting both WLAN and WPAN capabilities. RF 162 is coupled to one or more antennas 142 of the STA 140 and/or STA 150, which receive and transmit radio signals. In some embodiments, RF 162 is coupled to a single antenna shared between WLAN and WPAN communication, or to separate antennas dedicated to each communication type. RF 162 may include, but is not limited to, a low-noise amplifier (LNA), a power amplifier, one or more filters, and one or more switches. The LNA amplifies weak signals received by the antenna without significantly adding to the noise. The power amplifier increases the power of the signal to be sent out through the antenna, ensuring it is strong enough to reach the intended receiver. The one or more filters select the appropriate frequency bands for operation, such as 2.4 GHz or 5 GHz for WLAN and 2.4 GHz for WPAN, ensuring compliance with designated frequency bands and minimizing interference from other RF sources. The one or more switches alternate between transmission and reception modes in instances where a single antenna is used for both transmitting and receiving. In some embodiments, RF 162 may support both WLAN and WPAN operations within a single component across multiple frequency bands or may include separate components for each frequency band, depending on the implementation. Memory 166 includes, but is not limited to, one or more volatile memory and/or non-volatile memory used for store instructions, firmware, operational data, etc.

PHY 164 is configured to transmit and receive radio signals over one or more frequency bands, such as 2.4 GHz and/or 5 GHz. PHY 164 includes an adaptive modem component 126. The adaptive modem component 126 receives a wireless signal. The adaptive modem component 126 determines a wireless standard implemented by the wireless signal and a spreading technique of the wireless signal. For example, the adaptive modem component 126 analyzes waveform characteristics of the wireless signal to determine the wireless standard implemented by the wireless signal and a spreading technique of the wireless signal.

If the wireless standard implemented by the wireless signal is the WLAN standard, the adaptive modem component 126 determines whether the wireless signal contains beacon information. If the wireless signal does not contain beacon information, the adaptive modem component 126 process the wireless signal using a processing chain for the wireless standard and the spreading technique of the wireless signal. If the wireless signal contains beacon information, the adaptive modem component 126, using the wireless standard implemented by the wireless signal and the spreading technique of the wireless signal, obtains a pre-trained weight stored in memory 166 for the specific combination, for example the wireless standard implemented by the wireless signal and the spreading technique of the wireless signal. The adaptive modem component 126 applies the obtained pre-trained weight for the specific combination to an ML model trained to process a wireless signal to recover original data. The adaptive modem component 126 inputs the wireless signal into the ML model to recover original data of the wireless signal.

Similarly, if the wireless standard implemented by the wireless signal is the WPAN standard, the adaptive modem component 126, using the wireless standard implemented by the wireless signal and the spreading technique of the wireless signal, obtains a pre-trained weight stored in memory 166 for the specific combination The adaptive modem component 126 applies the obtained pre-trained weight for the specific combination to an ML model trained to process a wireless signal to recover original data. The adaptive modem component 126 inputs the wireless signal into the ML model to recover original data of the wireless signal.

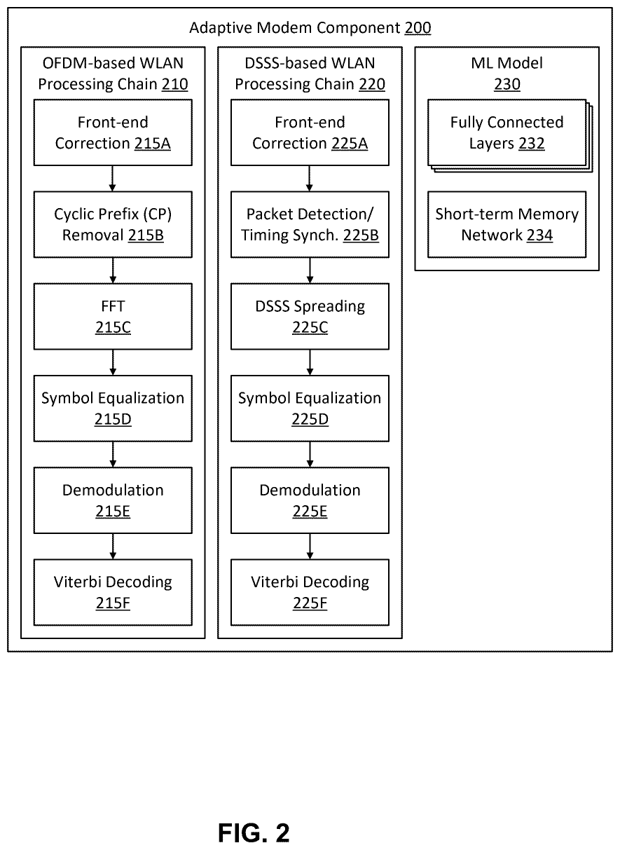

FIG. 2 is an exemplary diagram of an adaptive modem component 200, similar to adaptive modem component 126 of FIG. 1, in accordance with implementations of the present disclosure. The adaptive modem component 200 can include an ODFM-based WLAN processing chain 210, a DSSS-based WLAN processing chain 220, a machine learning (ML) model 230.

The ODFM-based WLAN processing chain 210 can include a front-end correction module 215A, a cyclic prefix (CP) removal module 215B, a fast fourier transform (FFT) module 215C, a symbol equalization module 215D, a demodulation module 215E, a VViterbi decoding module 215F. The front-end correction module 215A estimates and corrects for bias and branch imbalance (BBIQ) in the receiver frontend while also applying corrections for second-order intermodulation distortion (IMM2), significantly improving signal quality and reducing various forms of distortion. The CP removal module 215B eliminates the guard interval that was added during transmission, effectively reducing inter-symbol interference, and preparing the signal for frequency domain processing. The FFT module 215C transforms the time-domain signal into the frequency domain, allowing for efficient estimation of channel coefficients and extraction of data from individual subcarriers. The symbol equalization module 215D divides the received signal by known beacon symbols to achieve de-convolution, compensating for channel impairments and phase shifts introduced during transmission. The demodulation module 215E converts the equalized complex symbols back into their original binary form by mapping constellation points to bit sequences according to the specific modulation scheme used. The ViterbiViterbi decoding module 215F implements a powerful error correction algorithm that uses maximum likelihood sequence estimation to recover the original data stream even in the presence of transmission errors.

The DSSS-based WLAN processing chain 220 can include a front-end correction module 225A, a packet detection and timing synchronization module 225B, a DSSS dispreading module 225C, a symbol equalization module 225D, a demodulation module 225E, a ViterbiViterbi decoding module 225F. The front-end correction module 225A compensates for hardware imperfections in the receiver chain such as DC offset, I/Q imbalance, and phase noise, ensuring optimal signal quality before further processing. The packet detection and timing synchronization module 225B identifies the beginning of incoming packets by detecting preamble sequences and establishes precise timing alignment. The DSSS dispreading module 225C applies the appropriate spreading code to the received signal to reverse the spreading process, effectively collapsing the wideband signal back to its original narrowband form and providing processing gain against narrowband interference. The symbol equalization module 225D compensates for multipath fading and channel distortions by applying correction factors based on channel estimation. The demodulation module 225E converts the equalized baseband signal into a digital bit stream by mapping the received symbols to their corresponding bit values based on the modulation scheme used. The ViterbiViterbi decoding module 225F implements a convolutional decoding algorithm that provides forward error correction, significantly improving the packet reception reliability by recovering the original data even when some bits are corrupted during transmission.

The ML model 230 may include one or more fully connected layers (FCNs) 232 and a long short-term memory (LSTM) network 234, such as a bidirectional LSTM. FCNs 232 consist of layers where each neuron in one layer is connected to every neuron in the preceding and succeeding layers. Each neuron processes inputs by applying a weighted sum followed by an activation function, such as sigmoid, ReLU, or hyperbolic tangent, to introduce non-linearity. FCNs 232 are typically used to aggregate learned features from preceding layers and produce meaningful outputs, such as bit predictions or error corrections.

The LSTM network 234 is designed to process sequential dependencies in input signals using memory cells that selectively store, retain, or update information over time. Each memory cell consists of components such as an input gate, forget gate, output gate, and a cell state, which work together to capture long-term dependencies in the signal. The LSTM network dynamically adapts to varying channel conditions and noise, refining signal features, correcting distortions, and making predictions based on both past and current observations. Together, the FCNs 232 and LSTM network in the ML model 230 perform tasks associated with the various deterministic algorithms implemented in deterministic processing blocks of various standards. Deterministic processing blocks can be one of: FFT (associated with the OFDM-based WLAN standard), spreading/despreading (associated with the OFDM-based WLAN standard), filtering and timing recovery (associated with Bluetooth Classic standard), channel/symbol equalization (associated with all standards), demodulation (associated with all standards), and error correction using Viterbi decoding (associated with all standards).

Accordingly, the ML model 230 can be trained to handle tasks traditionally performed by the deterministic processing blocks of multiple standards. The ML model 230 may be trained to replace specific tasks of the OFDM-based WLAN standard, such as FFT, CP removal, channel equalization, demodulation, and decoding. Training may involve using datasets of simulated OFDM signals with modulations such as BPSK under varying noise, fading, and interference conditions. As a result, the ML model 230 learns to convert a time domain signal of the wireless signal to a frequency domain signal via FFT and CP, extract OFDM symbols via demodulation, and correct errors and recover original data via ViterbiViterbi decoding. More specifically, since the ML model 230 is trained using simulated OFDM signals with modulations such as BPSK, the ML model 230 is trained to processes a received beacon signal to extract the original bits representing the beacon information. After training the ML model 230 for a first type of wireless standard, such as the OFDM-based WLAN standard, weights of the ML model 230, which represent the learned parameters capturing the relationships and patterns specific to the OFDM-based WLAN standard, are stored in memory, such as the memory 166 of FIG. 1.

The ML model 230, after reinitializing the weights of the ML model 230, may be trained to replace specific tasks of the DSSS-based WLAN standard, such as spreading, despreading, channel equalization, demodulation, and decoding. Training may involve using datasets of simulated DSSS signals with spreading codes and modulations such as BPSK under varying noise, fading, and interference conditions. As a result, the ML model 230 learns to compensate for multipath effects and fading, such as channel equalization, extract the spread-spectrum symbols (e.g., demodulation), and correct errors and recover original data, such as Viterbi decoding. More specifically, since the ML model 230 is trained using simulated DSSS signals with spreading codes and modulations such as BPSK, the ML model 230 is trained to processes a received beacon signal to extract the original bits representing the beacon information. After training the ML model 230 for a second type of wireless standard, such as the DSSS-based WLAN standard, weights of the ML model 230, which represent the learned parameters capturing the relationships and patterns specific to the DSSS-based WLAN standard, are stored in memory, such as the memory 166 of FIG. 1.

The ML model 230, after reinitializing the weights of the ML model 230, may be trained for the WPAN standard to replace specific tasks of the WPAN standard, such as pilot signal processing, data detection, channel equalization, demodulation, and decoding. Training may involve using datasets of simulated WPAN signals, which can include pilot signals and their corresponding data, with modulations such as BPSK or QPSK under varying noise, fading, and interference conditions. As a result, the ML model 230 learns to align the receiver with the transmitter's frequency via frequency offset correction, extract symbols from the frequency-modulated signal via GFSK demodulation, correct errors and recover original data via Viterbi decoding, and/or reverse the data whitening applied at the transmitter via de-whitening. After training the ML model 230 for a third type of wireless standard, such as the WPAN standard, weights of the ML model 230, which represent the learned parameters capturing the relationships and patterns specific to the WPAN standard, are stored in memory 166.

The ML model 230, while trained for the OFDM-based WLAN standard, the DSSS-based WLAN standard, and the WPAN standard, can be further trained for various other standards, as well as other technologies that influence signal processing, such as enhanced single-multi-user multiple input multiple output (ESMLR), which enhances performance in single-user and multi-user multiple input multiple output (MIMO) systems, utilizing multiple antennas at the transmitter and receiver to improve data throughput, reliability, and spectral efficiency.

When implementing the ML model 230 for a particular standard, weights (or pre-trained weights) associated with the particular standard can be loaded from memory, such as the memory 166 of FIG. 1 into the ML model 230, allowing the ML model 230 to process signals efficiently without requiring multiple ML models or retraining of the ML model 230. This provides flexibility and scalability, as the ML model 230 can be switched between standards by loading the corresponding weights, ensuring efficient operation tailored to the desired wireless communication protocol.

In operation, the adaptive modem component 200 may receive a wireless signal. The adaptive modem component 200 analyzes waveform characteristics of the wireless signal. Based on the waveform characteristics of the wireless signal, the adaptive modem component 200 determines a wireless standard implemented by the wireless signal and a spreading technique of the wireless signal.

If the wireless standard implemented by the wireless signal is the WLAN standard and the spreading technique of the wireless signal is ODFM, the adaptive modem component 200 determines whether the wireless signal contains beacon information. If the wireless signal contains beacon information, the adaptive modem component 200 obtains weights for the ODFM-based WLAN standard. The adaptive modem component 200 applies the weights for the ODFM-based WLAN standard to the ML model 230. The adaptive modem component 200 provides the wireless signal to ML model (which has the appropriate weights applied) to recover original data of the wireless signal. If the wireless signal does not contain beacon information, the adaptive modem component 200 provides the wireless signal to a processing chain for the ODFM-based WLAN standard to recover original data of the wireless signal.

If the wireless standard implemented by the wireless signal is the WLAN standard and the spreading technique of the wireless signal is DSSS, the adaptive modem component 200 determines whether the wireless signal contains beacon information. If the wireless signal contains beacon information, the adaptive modem component 200 obtains weights for the DSSS-based WLAN standard. The adaptive modem component 200 applies the weights for the DSSS-based WLAN standard to the ML model 230. The adaptive modem component 200 provides the wireless signal to ML model (which has the appropriate weights applied) to recover original data of the wireless signal. If the wireless signal does not contain beacon information, the adaptive modem component 200 provides the wireless signal to a processing chain for the DSSS-based WLAN standard to recover original data of the wireless signal.

If the wireless standard implemented by the wireless signal is the WPAN standard, the adaptive modem component 200 obtains weights for the WPAN standard. The adaptive modem component 200 applies the weights for the WPAN standard to the ML model 230. The adaptive modem component 200 provides the wireless signal to ML model (which has the appropriate weights applied) to recover original data of the wireless signal.

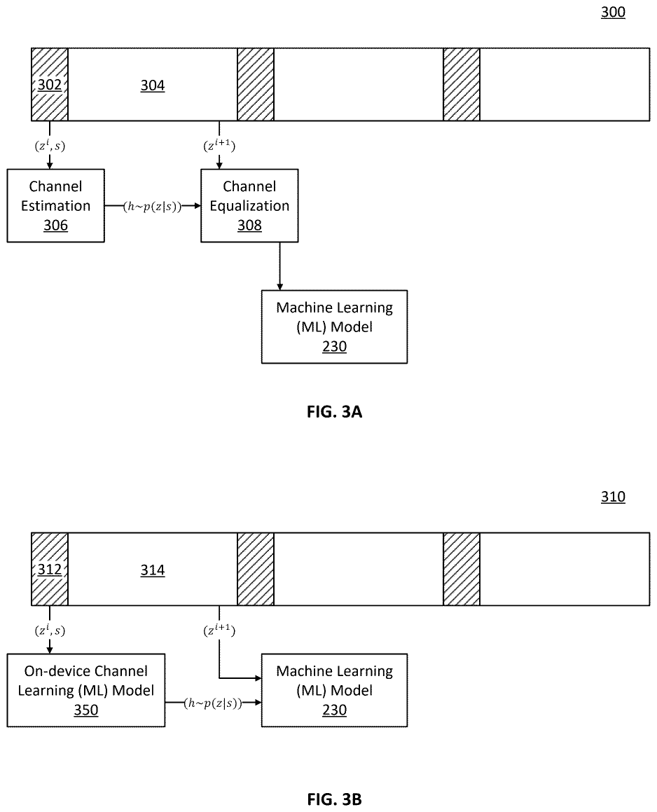

In some embodiments, with quick reference to FIG. 3A, the adaptive modem component 200, after receiving the wireless signal, processes the wireless signal. The wireless signal contains reference signal(s) 302 in certain time slots (zⁱ) that are known to both transmitter and receiver, as well as data symbols 304 in subsequent time slots (zⁱ⁺¹). The adaptive modem component performs channel estimation 306 by analyzing how the reference signal 302 was affected during transmission, comparing these received reference signal with their known original value to construct a mathematical model of the current channel conditions expressed as (h p(z∨s)). The adaptive modem component 200 then performs channel equalization 308, using the channel estimate, by applying this channel model to the subsequent time slots (zi+1) containing the data symbols 304, effectively undoing the distortions introduced during transmission. Thus, the adaptive modem component 200 dynamically adjusts to changing channel conditions, ensuring optimal signal recovery even in challenging wireless environments. The adaptive modem component 200 outputs an equalized wireless signal where channel impairments have been removed from the data symbols, enabling accurate recovery of the originally transmitted information. The adaptive modem component 200 obtains weights for the WPAN standard. The adaptive modem component 200 obtains weights for the WPAN standard. The adaptive modem component 200 applies the weights for the WPAN standard to the ML model 230. The adaptive modem component 200 provides the equalized wireless signal to ML model 230 to perform channel demodulation and decoding to recover original data of the wireless signal expressed as ŝᵢ₊₁.

In some embodiments, with quick reference to FIG. 3B, the adaptive modem component 200 may include an additional ML model, such as an on-device channel learning ML model 350. The on-device channel learning ML model 350 processes the reference signals (e.g., reference signal(s) 312 in certain time slots (zⁱ)) by performing channel estimation by analyzing how the reference signals were affected during transmission, comparing these received reference signals with their known original values to construct a mathematical model of the current channel conditions expressed as (h p(z∨s)) using channel estimation. The adaptive modem component 200 provides the channel estimate and the data symbols 304 in subsequent time slots (zⁱ⁺¹) to the ML model 230 to perform channel equalization, demodulation, and decoding to recover original data of the wireless signal expressed as ŝᵢ₊₁.

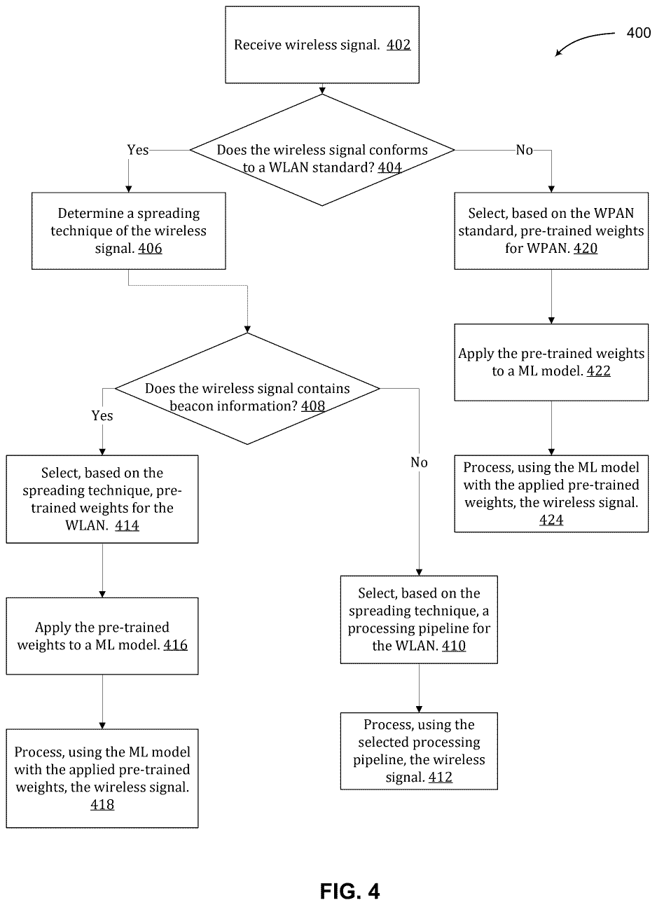

FIG. 4 depicts a flow diagram of an example method 400 for processing wireless signals via an adaptive modem, in accordance with implementations of the present disclosure. Method 400 can be performed by a processing logic that can include hardware (circuitry, dedicated logic, etc.), software (e.g., instructions run on a processing device), or a combination thereof. In one implementation, some, or all of the operations of method 400 can be performed by one or more components of the adaptive modem component 126 of FIG. 1 or adaptive modem component 200 of FIG. 2, as described above.

At block 402, the processing logic receive wireless signal. At block 404, the processing logic determines whether the wireless signal conforms to a WLAN standard. If yes, indicating that the wireless signal conforms to a WLAN standard, at block 406, the processing logic determines a spreading technique of the wireless signal.

At block 408, the processing logic determines whether the wireless signal contains beacon information. If no, indicating that the wireless signal does not contain beacon information, at block 410, the processing logic selects, based on the spreading technique, a processing pipeline for the WLAN. At block 412, the processing logic processes, using the selected processing pipeline, the wireless signal to recover one or more bits from the wireless signal, such as data. If yes, indicating that the wireless signal does contain beacon information, at block 414, the processing logic selects, based on the spreading technique, pre-trained weights for the WLAN. At block 416, the processing logic applies the pre-trained weights to a ML model. At block 418, the processing logic processes, using the ML model with the applied pre-trained weights, the wireless signal to recover one or more bits from the wireless signal, such as beacon information.

If no, indicating that the wireless signal does not conform to a WLAN standard but a WPAN standard, at block 420, the processing logic selects, based on the WPAN standard, pre-trained weights for WPAN. At block 422, the processing logic applies the pre-trained weights to a ML model. At block 424, the processing logic processes, using the ML model with the applied pre-trained weights, the wireless signal to recover one or more bits from the wireless signal.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, refer to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer-readable medium; or a combination thereof.

The aforementioned systems, circuits, modules, and so on have been described with respect to interaction between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include a collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot be determined from the collected data.

What is claimed is:

1. A method comprising:
receiving a wireless signal transmitted by an access point;
identifying waveform characteristics of the wireless signal;
determining, based on the waveform characteristics, whether the wireless signal contains beacon information;
determining, based on the waveform characteristics, a wireless standard for the wireless signal;
responsive to determining that the wireless standard is a first type of wireless standard and that the wireless signal contains beacon information, obtaining a first pre-trained weight set for the first type of wireless standard, wherein the first type of wireless standard implemented by the wireless signal is wireless local area network (WLAN) with a spreading technique of orthogonal frequency division multiplexing (OFDM);
applying the first pre-trained weight set to a first machine learning (ML) model to configure the first ML model for the first type of wireless standard; and
recovering, using the first ML model configured for the first type of wireless standard, one or more bits of the beacon information from the wireless signal.

2. The method of claim 1, wherein recovering, using the first ML model configured for the first type of wireless standard, one or more bits of the beacon information from the wireless signal comprises:
converting a time domain signal of the wireless signal to a frequency domain signal;
extracting OFDM symbols from the frequency domain signal; and
recovering the one or more bits of the beacon information from the OFDM symbols.

3. The method of claim 1, further comprising:
responsive to determining that the wireless standard is a second type of wireless standard and that the wireless signal contains beacon information, obtaining a second pre-trained weight set for the second type of wireless standard, wherein the second type of wireless standard implemented by the wireless signal is the WLAN with a spreading technique of direct sequence spread spectrum (DSSS);
applying the second pre-trained weight set to the first ML model to configure the first ML model for the second type of wireless standard; and
recovering, using the first ML model configured for the second type of wireless standard, one or more bits of the beacon information from the wireless signal.

4. The method of claim 3, wherein recovering, using the first ML model configured for the second type of wireless standard, one or more bits from the wireless signal comprises:
performing channel equalization on the wireless signal;
extracting symbols from the equalized wireless signal; and
recovering the one or more bits from the symbols.

5. The method of claim 1, further comprising:
responsive to determining that the wireless standard is a third type of wireless standard, obtaining a third pre-trained weight set for the third type of wireless standard, obtaining a third pre-trained weight set for the third type of wireless standard, wherein the third type of wireless standard implemented by the wireless signal is wireless personal area network (WPAN);
applying the third pre-trained weight set to the first ML model to configure the first ML model for the third type of wireless standard; and
recovering, using the first ML model configured for the third type of wireless standard, one or more bits from the wireless signal.

6. The method of claim 5, wherein recovering, using the first ML model configured for the third type of wireless standard, one or more bits from the wireless signal:
performing channel estimation on a reference signal to obtain a channel estimate of the wireless signal;
performing channel equalization on data of the wireless signal using the channel estimate to obtain an equalized wireless signal; and
recovering, using the first ML model configured for the third type of wireless standard, the one or more bits from the equalized wireless signal.

7. The method of claim 6, wherein channel estimation is performed by a second ML model, and wherein recovering, using the first ML model configured for the third type of wireless standard, the one or more bits from the wireless signal based on the channel estimate.

8. A station device comprising:
a physical layer (PHY) to perform operations comprising:
receiving a wireless signal transmitted by an access point;
identifying waveform characteristics of the wireless signal;
determining, based on the waveform characteristics, whether the wireless signal contains beacon information;
determining, based on the waveform characteristics, a wireless standard for the wireless signal;
responsive to determining that the wireless standard implemented by the wireless signal is a first type of wireless standard and that the wireless signal contains beacon information, obtaining a first pre-trained weight set for the first type of wireless standard, wherein the first type of wireless standard implemented by the wireless signal is wireless local area network (WLAN) with a spreading technique of orthogonal frequency division multiplexing (OFDM);
applying the first pre-trained weight set to a first machine learning (ML) model to configure the first ML model for the first type of wireless standard; and
recovering, using the first ML model configured for the first type of wireless standard, one or more bits of the beacon information from the wireless signal.

9. The station device of claim 8, wherein recovering, using the first ML model configured for the first type of wireless standard, one or more bits of the beacon information from the wireless signal comprises:
converting a time domain signal of the wireless signal to a frequency domain signal;
extracting OFDM symbols from the frequency domain signal; and
recovering the one or more bits of the beacon information from the OFDM symbols.

10. The station device of claim 8, wherein the PHY is to perform operations further comprising:
responsive to determining that the wireless standard implemented by the wireless signal is a second type of wireless standard and that the wireless signal contains beacon information, obtaining a second pre-trained weight set for the second type of wireless standard, wherein the second type of wireless standard implemented by the wireless signal is the WLAN with a spreading technique of direct sequence spread spectrum (DSSS);
applying the second pre-trained weight set to the first ML model to configure the first ML model for the second type of wireless standard; and
recovering, using the first ML model configured for the second type of wireless standard, one or more bits of the beacon information from the wireless signal.

11. The station device of claim 10, wherein recovering, using the first ML model configured for the second type of wireless standard, one or more bits from the wireless signal comprises:
performing channel equalization on the wireless signal;
extracting symbols from the equalized wireless signal; and
recovering the one or more bits from the symbols.

12. The station device of claim 8, wherein the PHY is to perform operations further comprising:
responsive to determining that the wireless standard implemented by the wireless signal is a third type of wireless standard, obtaining a third pre-trained weight set for the third type of wireless standard, obtaining a third pre-trained weight set for the third type of wireless standard, wherein the third type of wireless standard implemented by the wireless signal is wireless personal area network (WPAN);
applying the third pre-trained weight set to the first ML model to configure the first ML model for the third type of wireless standard; and
recovering, using the first ML model configured for the third type of wireless standard, one or more bits from the wireless signal.

13. The station device of claim 12, wherein recovering, using the first ML model configured for the third type of wireless standard, one or more bits from the wireless signal:
performing channel estimation on a reference signal to obtain a channel estimate of the wireless signal;
performing channel equalization on data of the wireless signal using the channel estimate to obtain an equalized wireless signal; and
recovering, using the first ML model configured for the third type of wireless standard, the one or more bits from the equalized wireless signal.

14. The station device of claim 13, wherein channel estimation is performed by a second ML model, and wherein recovering, using the first ML model configured for the third type of wireless standard, the one or more bits from the wireless signal based on the channel estimate.

15. A wireless network comprising:
an access point (AP); and
a station device, wherein a physical layer (PHY) of the station device is to perform operations comprising:
receiving a wireless signal transmitted by the AP;
identifying waveform characteristics of the wireless signal;
determining, based on the waveform characteristics, whether the wireless signal contains beacon information;
determining, based on the waveform characteristics, a wireless standard for the wireless signal;
responsive to determining that the wireless standard implemented by the wireless signal is a first type of wireless standard and that the wireless signal contains beacon information, obtaining a first pre-trained weight set for the first type of wireless standard, wherein the first type of wireless standard implemented by the wireless signal is wireless local area network (WLAN) with a spreading technique of orthogonal frequency division multiplexing (OFDM);
applying the first pre-trained weight set to a first machine learning (ML) model to configure the first ML model for the first type of wireless standard; and
recovering, using the first ML model configured for the first type of wireless standard, one or more bits of the beacon information from the wireless signal.

16. The wireless network of claim 15, wherein recovering, using the first ML model configured for the first type of wireless standard, one or more bits of the beacon information from the wireless signal comprises:
converting a time domain signal of the wireless signal to a frequency domain signal;
extracting OFDM symbols from the frequency domain signal; and
recovering the one or more bits of the beacon information from the OFDM symbols.

17. The wireless network of claim 15, wherein the PHY of the station device is to perform operations further comprising:
responsive to determining that the wireless standard implemented by the wireless signal is a second type of wireless standard and that the wireless signal contains beacon information, obtaining a second pre-trained weight set for the second type of wireless standard, wherein the second type of wireless standard implemented by the wireless signal is the WLAN with a spreading technique of direct sequence spread spectrum (DSSS);
applying the second pre-trained weight set to the first ML model to configure the first ML model for the second type of wireless standard; and
recovering, using the first ML model configured for the second type of wireless standard, one or more bits of the beacon information from the wireless signal.

18. The wireless network of claim 17, wherein recovering, using the first ML model configured for the second type of wireless standard, one or more bits from the wireless signal comprises:
performing channel equalization on the wireless signal;
extracting symbols from the equalized wireless signal; and
recovering the one or more bits from the symbols.

19. The wireless network of claim 15, wherein the PHY of the station device is to perform operations further comprising:
responsive to determining that the wireless standard implemented by the wireless signal is a third type of wireless standard, obtaining a third pre-trained weight set for the third type of wireless standard, obtaining a third pre-trained weight set for the third type of wireless standard, wherein the third type of wireless standard implemented by the wireless signal is wireless personal area network (WPAN);
applying the third pre-trained weight set to the first ML model to configure the first ML model for the third type of wireless standard; and
recovering, using the first ML model configured for the third type of wireless standard, one or more bits from the wireless signal.

20. The wireless network of claim 19, wherein recovering, using the first ML model configured for the third type of wireless standard, one or more bits from the wireless signal:
performing channel estimation on a reference signal to obtain a channel estimate of the wireless signal;
performing channel equalization on data of the wireless signal using the channel estimate to obtain an equalized wireless signal; and
recovering, using the first ML model configured for the third type of wireless standard, the one or more bits from the equalized wireless signal.
